(19) United States
(12) Patent Application Publication
(10) Pub. No.: US 2023/0291212 A1
(43) Pub. Date: Sep. 14, 2023

(54) POWER SUPPLY SYSTEM

(71) Applicant: TOYOTA JIDOSHA KABUSHIKI KAISHA, Toyota-shi (JP)

(72) Inventors: Takuya MIZUNO, Nagakute-shi (JP); Shuji TOMURA, Nagakute-shi (JP); Naoki YANAGIZAWA, Nagakute-shi (JP); Kazuo OOTSUKA, Nagakute-shi (JP); Hiroshi TSUKADA, Nagakute-shi (JP); Junta IZUMI, Nagoya-shi (JP); Masakazu HABU, Toyota-shi (JP); Kenji KIMURA, Nagoya-shi (JP); Hironori MIKI, Nagoya-shi (JP); Yasuhiro ENDO, Okazaki-shi (JP); Takayuki BAN, Nishio-shi (JP)

(73) Assignee: TOYOTA JIDOSHA KABUSHIKI KAISHA, Toyota-shi (JP)

(21) Appl. No.: 18/147,785

(22) Filed: Dec. 29, 2022

(30) Foreign Application Priority Data
Mar. 11, 2022 (JP) 2022-038095

(51) Int. Cl. H02J 7/00

(52) U.S. Cl. CPC H02J 7/0031; H02J 7/0013; H02J 7/0048; H02J 7/007182

(57) ABSTRACT

A power supply system includes a forcible disconnecting unit configured to forcibly disconnect a battery in a battery module from series regardless of a gate drive signal. The power supply system obtains the number of batteries included in the battery modules which can be forcibly disconnected from the series according to the maximum voltage of the batteries that can be connected in the series and a voltage command value indicating a voltage to be output, and forcibly disconnects the obtained number of the batteries from the series by the forcible disconnecting unit.

### CROSS-REFERENCE TO RELATED APPLICATION

This application claims priority to Japanese Patent Application No. 2022-038095 filed on Mar. 11, 2022, incorporated herein by reference in its entirety.

### BACKGROUND

### 1. Technical Field

The present disclosure relates to a power supply system.

### 2. Description of Related Art

A power supply device in which a plurality of battery modules is connected in series to supply (power-run) power to a load is used. When a battery included in the battery module is a secondary battery, it is also possible to charge (regenerate) the battery from the load side. Among such power supply devices, a power supply device that includes a switching circuit that connects or disconnects each battery module to or from a load based on a gate drive signal has been proposed (Japanese Unexamined Patent Application Publication No. 2018-174607).

### SUMMARY

In the power supply system of the related art, states of charge (SOCs) of the batteries included in respective power supply modules are equalized by disconnecting an arbitrary power supply module of the power supply modules constituting as string of each phase from series regardless of a voltage command value or an on time. In order to ensure the maximum value of an output voltage in a state where the power supply module is disconnectable from the series to equalize the SOCs, it is necessary to provide an extra power supply module. Therefore, there is a risk that the manufacturing cost of the power supply system will increase, or that the utilization rate of the battery will decrease.

A power supply system according to a first aspect of the present disclosure uses a plurality of sets of battery module groups each including a plurality of battery modules with batteries and makes the batteries in the battery modules to be connectable in series based on a gate drive signal from a controller. The power supply system includes a forcible disconnecting unit configured to forcibly disconnect the battery in the battery module from the series regardless of the gate drive signal. The power supply system is configured to obtain the number of batteries included in the battery modules which are forcibly disconnectable from the series according to a maximum voltage of the batteries that are connectable in the series and a voltage command value indicating a voltage to be output, and forcibly disconnect the obtained number of the batteries from the series by the forcible disconnecting unit.

A power supply system according to a second aspect of the present disclosure uses a plurality of sets of battery module groups each including a plurality of battery modules with batteries and makes the batteries in the battery modules to be connectable in series based on a gate drive signal from a controller. The power supply system includes a forcible disconnecting unit configured to forcibly disconnect the battery in the battery module from the series regardless of the gate drive signal. The power supply system is configured to obtain the number of batteries included in the battery modules which are forcibly disconnectable from the series according to a maximum allowance on-time and an on-time command, and forcibly disconnect the obtained number of the batteries from the series by the forcible disconnecting unit.

In the first aspect or the second aspect, the power supply system may perform, when there is a margin in an output voltage with respect to a maximum voltage of the batteries that are connectable in the series, a process of forcibly disconnecting the obtained the number of the batteries from the series by the forcible disconnecting unit.

In the first aspect or the second aspect, the power supply system may perform, during discharging, a process of forcibly disconnecting the obtained number of the batteries from the series by the forcible disconnecting unit in ascending order of state of charge (SOC).

In the first aspect or the second aspect, the power supply system may perform, during charging, a process of forcibly disconnecting the obtained number of the batteries from the series by the forcible disconnecting unit in descending order of SOC.

In the first aspect or the second aspect, the power supply system may make at least three sets of the battery module groups Y-connected, and cause the battery module groups to respectively output alternating current voltages with a 120° phase difference.

With each aspect of the present disclosure, a power supply system that can effectively use the battery can be provided while reducing the extra power supply module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a basic configuration of a power supply device according to an embodiment of the present disclosure;

FIG. 2 is a time chart illustrating control of a battery module according to the embodiment of the present disclosure;

FIG. 3A is a diagram illustrating operation of the battery module according to the embodiment of the present disclosure;

FIG. 3B is a diagram illustrating operation of the battery module according to the embodiment of the present disclosure;

FIG. 4 is a time chart illustrating control of the power supply device according to the embodiment of the present disclosure;

FIG. 5 is a time chart illustrating a specific example of forced disconnection control according to the embodiment of the present disclosure;

FIG. 6 is a diagram illustrating a configuration of a three-phase AC power supply according to the embodiment of the present disclosure;

FIG. 7 is a diagram illustrating string voltages in three-phase equilibrium output from the three-phase AC power supply according to the embodiment of the present disclosure;

FIG. 8 is a diagram illustrating phase-to-phase voltages in three-phase equilibrium output from the three-phase AC power supply according to the embodiment of the present disclosure;

FIG. 9A is a diagram illustrating an example of temporal changes in a phase voltage, a string current, a battery current, and a duty ratio according to the embodiment of the present disclosure;

FIG. 9B is a diagram illustrating an example of the temporal changes in the phase voltage, the string current, the battery current, and the duty ratio according to the embodiment of the present disclosure;

FIG. 9C is a diagram illustrating an example of the temporal changes in the phase voltage, the string current, the battery current, and the duty ratio according to the embodiment of the present disclosure;

FIG. 10 illustrates a flowchart of long cycle control in a first control method of the present disclosure;

FIG. 11 illustrates a flowchart of short cycle control in the first control method of the present disclosure;

FIG. 12 is a diagram illustrating a specific configuration example of the three-phase AC power supply according to the embodiment of the present disclosure;

FIG. 13 is a block diagram of system interconnection control of the three-phase AC power supply according to the embodiment of the present disclosure;

FIG. 14 is a block diagram of system interconnection control of the three-phase AC power supply according to the embodiment of the present disclosure;

FIG. 15 illustrates a flowchart of short cycle control in a second control method of the present disclosure;

FIG. 16 is a diagram illustrating a population distribution of battery capacity used in a simulation in the embodiment of the present disclosure;

FIG. 17 is a diagram illustrating a simulation result of AC active balance control in the embodiment of the present disclosure;

FIG. 18 is a diagram illustrating a simulation result of DC active balance control in the embodiment of the present disclosure;

FIG. 19 is a diagram illustrating a simulation result without active balance control in the embodiment of the present disclosure;

FIG. 20 is a diagram illustrating a population distribution of battery capacity used in a simulation in the embodiment of the present disclosure;

FIG. 21 is a diagram illustrating a simulation result of AC active balance control in the embodiment of the present disclosure;

FIG. 22 is a diagram illustrating a simulation result of DC active balance control in the embodiment of the present disclosure;

FIG. 23 is a diagram illustrating a simulation result without active balance control in the embodiment of the present disclosure;

FIG. 24 is a diagram illustrating a simulation result of an average value of battery capacity exhaustion rate in the embodiment of the present disclosure; and

FIG. 25 is a diagram illustrating a simulation result of the minimum value of the battery capacity exhaustion rate in the embodiment of the present disclosure.

### DETAILED DESCRIPTION OF EMBODIMENTS

Basic Configuration of Power Supply Circuit

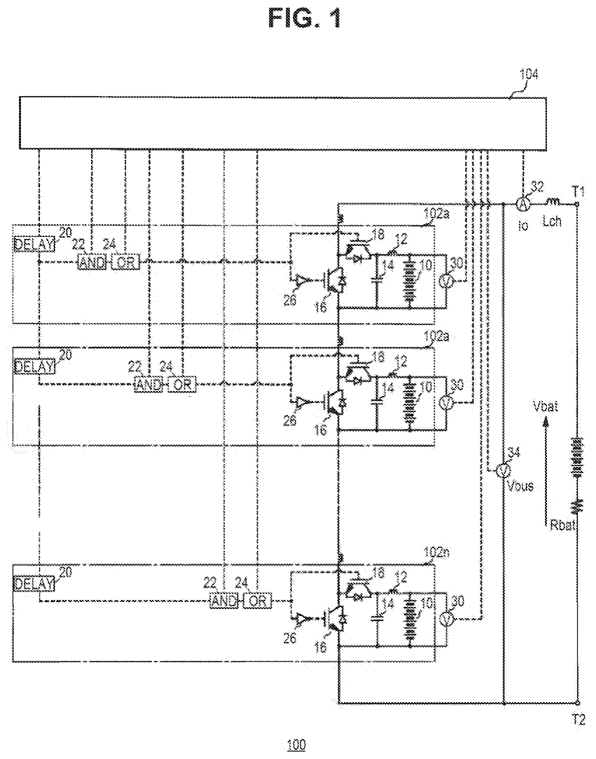

A power supply circuit 100 (power supply module group) according to a present embodiment includes a battery module 102 and a controller 104 as illustrated in FIG. 1. The power supply circuit 100 includes a plurality of battery modules 102 (102a, 102b, . . . , 102n). The plurality of battery modules 102 included in the power supply circuit 100 can supply (power-run) power to a load (not illustrated) connected to terminals T1 and T2, or charge (regenerate) power from a power supply (not illustrated) connected to the terminals T1 and T2.

The battery module 102 includes a battery 10, a choke coil 12, a capacitor 14, a first switch element 16, a second switch element 18, a gate drive signal processing circuit 20, an AND element 22, an OR element 24, and a NOT element 26. In the present embodiment, each battery module 102 has the same configuration. The batteries 10 in the battery modules 102 included in each power supply circuit 100 can be connected in series with each other under the control of the controller 104.

The battery 10 includes at least one secondary battery. The battery 10 can have, for example, a configuration in which a plurality of lithium-ion batteries, nickel-hydrogen batteries, or the like are connected in series or/and in parallel. The choke coil 12 and the capacitor 14 constitute a smoothing circuit (low-pass filter circuit) that smooths the output from the battery 10 and outputs the smoothed output. That is, since a secondary battery is used as the battery 10, in order to suppress deterioration of the battery 10 due to an increase in internal resistance loss, the battery 10, the choke coil L, and the capacitor 14 form an RLC filter to level the current. The choke coil 12 and the capacitor 14 are not essential components and may be omitted.

The first switch element 16 includes a switch element for short-circuiting an output terminal of the battery 10. In the present embodiment, the first switch element 16 has a configuration in which a freewheeling diode is connected in parallel with a field effect transistor that is a switch element. The second switch element 18 is connected in series with the battery 10 between the battery 10 and the first switch element 16. In the present embodiment, the second switch element 18 has a configuration in which a freewheeling diode is connected in parallel with a field effect transistor that is a switch element. The first switch element 16 and the second switch element 18 are switching-controlled by a gate drive signal from the controller 104. In the present embodiment, field effect transistors are used as the first switch element 16 and the second switch element 18, but other types of switch elements such as IGBTs may be applied.

The gate drive signal processing circuit 20 is a circuit that controls the battery module 102 based on a gate drive signal input from the controller 104 to the battery module 102. The gate drive signal processing circuit 20 includes a delay circuit that delays the gate drive signal by a predetermined time. In the power supply circuit 100, the battery modules 102 (102a, 102b, . . . , 102n) are respectively provided with the gate drive signal processing circuits 20, which are connected in series. Therefore, the gate drive signal input from the controller 104 is sequentially input to each battery module 102 (102a, 102b, . . . , 102n) while being delayed by a predetermined time. Control based on the gate drive signal will be described below.

The AND element 22 constitutes a disconnection unit for forcibly disconnecting the battery 10 in the battery module 102 from a series connection state in response to a forced disconnection signal. Also, the OR element 24 constitutes a connection unit for forcibly connecting the battery 10 in the battery module 102 in a series connection state in response to a forced connection signal. The AND element 22 and the OR element 24 are controlled by receiving the forced disconnection signal or the forced connection signal from the controller 104. A control signal from the controller 104 is input to one input terminal of the AND element 22, and a gate drive signal from the gate drive signal processing circuit 20 is input to the other input terminal. A control signal from the controller 104 is input to one input terminal of the OR element 24, and a gate drive signal from the gate drive signal processing circuit 20 is input to the other input terminal. Output signals from the AND element 22 and the OR element 24 are input to a gate terminal of the second switch element 18. Output signals from the AND element 22 and the OR element 24 are input to a gate terminal of the first switch element 16 via the NOT element 26.

During normal control, a high (H) level control signal is input from the controller 104 to the AND element 22 and a low (L) level control signal is input to the OR element 24. Therefore, the gate drive signal is input to the gate terminal of the second switch element 18 as it is, and a signal obtained by inverting the gate drive signal is input to the gate terminal of the first switch element 16. As a result, when the gate drive signal is at a high (H) level, the first switch element 16 is in an OFF state and the second switch element 18 is in an ON state, and when the gate drive signal is at a low (L) level, the first switch element 16 is in an ON state and the second switch element 18 is in an OFF state. That is, when the gate drive signal is at the high (H) level, the battery 10 in the battery module 102 is connected in series with the batteries 10 in the other battery modules 102, and when the gate drive signal is at the low (L) level, the battery 10 in the battery module 102 is in a through state separated from the batteries 10 in the other battery modules 102.

During forced disconnection, the controller 104 transmits a forced disconnection signal to the AND element 22 and OR element 24 of the battery module 102 to be forcibly disconnected. A low (L) level control signal (forced disconnection signal) is input from the controller 104 to the AND element 22, and a low (L) level control signal (forced disconnection signal) is input to the OR element 24. As a result, a low (L) level is output from the AND element 22, and a high (H) level is input to the gate terminal of the first switch element 16 by the NOT element 26 via the OR element 24, and further, a low (L) level is input to the gate terminal of the second switch element 18 via the OR element 24. Therefore, the first switch element 16 is always in an ON state and the second switch element 18 is always in an OFF state, and thus the battery 10 in the battery module 102 is in a state (pass-through state) of being forcibly disconnected from the series regardless of the state of the gate drive signal.

Such forced disconnection control can be used for control to suppress the imbalance of states of charges (SOCs) of the batteries 10 in the battery modules 102 in the power supply circuit 100. That is, when the power supply circuit 100 is in a discharging state, the SOC of the battery 10 in the battery module 102 involved in the output of the power supply circuit 100 decreases, whereas the SOC of the battery 10 in the battery module 102 can be maintained by putting the battery 10 in the battery module 102 into a forced disconnection state. Also, when the power supply circuit 100 is in a charging state, the SOC of the battery 10 in the battery module 102 involved in charging the power supply circuit 100 increases, whereas the SOC of the battery 10 in the battery module 102 can be maintained by putting the battery 10 in the battery module 102 into a forced disconnection state.

During forced connection, the controller 104 transmits a forced connection signal to the AND element 22 and OR element 24 of the battery module 102 to be forcedly connected. A high (H) level control signal (forced connection signal) is input from the controller 104 to the OR element 24 of the battery module 102. As a result, a high (H) level is output from the OR element 24, and a low (L) level is input to the gate terminal of the first switch element 16 by the NOT element 26, and further, a high (H) level is input to the gate terminal of the second switch element 18. Therefore, the first switch element 16 is always in an OFF state and the second switch element 18 is always in an ON state, and thus the battery 10 in the battery module 102 is forcibly connected in series regardless of the state of the gate drive signal.

Such forced connection control can be used for control to suppress the imbalance of the SOCs of the batteries 10 in the battery modules 102 in the power supply circuit 100. That is, when the power supply circuit 100 is in a discharging state, the SOC of the battery 10 in the battery module 102 intermittently connected in series according to the gate drive signal decreases, whereas the SOC of the battery 10 in the battery module 102 in the forced connection state can be decreased more quickly. Also, when the power supply circuit 100 is in a charging state, the SOC of the battery 10 in the battery module 102 intermittently connected in series according to the gate drive signal increases, whereas the SOC of the battery 10 in the battery module 102 in the forced connection state can be increased more quickly.

In the power supply circuit 100 according to the present embodiment, either or both of the AND element 22 and the OR element 24 are directly controlled by the controller 104. However, the AND element 22 and the OR element 24 may be controlled by the controller 104 via the gate drive signal processing circuit 20.

Normal Control

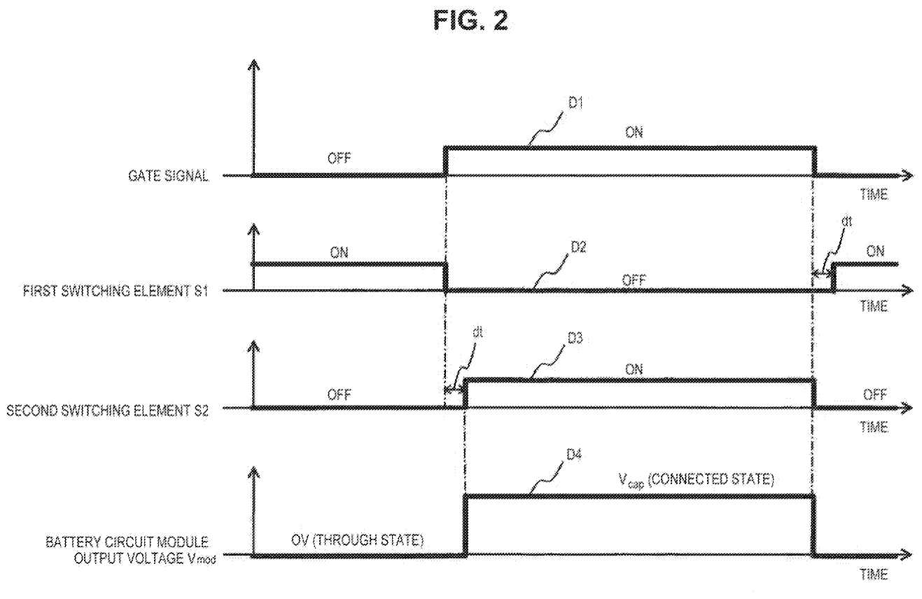

The control of the power supply circuit 100 will be described below with reference to FIG. 2. During normal control, a high (H) level control signal is input from the controller 104 to the AND elements 22 of the respective battery modules 102 (102a, 102b, . . . , 102n). Also, a low (L) level control signal is input from the controller 104 to the OR elements 24 of the respective battery modules 102 (102a, 102b, . . . , 102n). Therefore, the gate drive signal from the gate drive signal processing circuit 20 is input to the gate teminal of the first switch element 16 as an inverted signal via the NOT element 26, and the gate drive signal from the gate drive signal processing circuit 20 is input to the gate terminal of the second switch element 18 as it is.

FIG. 2 illustrates a time chart regarding the operation of the battery module 102a. FIG. 2 also shows a pulse waveform of a gate drive signal D1 for driving the battery module 102a, a rectangular wave D2 indicating the switching state of the first switch element 16, a rectangular wave D3 indicating the switching state of the second switch element 18, and a waveform D4 of a voltage V_{mod} output by the battery module 102a.

In an initial state of the battery module 102a, that is, when the gate drive signal is not output, the first switch element 16 is in the ON state and the second switch element 18 is in the OFF state. When a gate drive signal is input from the controller 104 to the battery module 102a, the battery module 102a is switching-controlled by PWM control. In this switching control, the first switch element 16 and the second switch element 18 are alternately switched ON/OFF.

As illustrated in FIG. 2, when the gate drive signal D1 is output from the controller 104, the first switch element 16 and the second switch element 18 of the battery module 102a are driven according to the gate drive signal D1. The first switch element 16 is switched from the ON state to the OFF state by the fall of the signal from the NOT element 26 corresponding to the rise of the gate drive signal D1. Also, the first switch element 16 switches from the OFF state to the ON state with a slight time delay (dead time dt) from the fall of the gate drive signal D1.

On the other hand, the second switch element 18 switches from the OFF state to the ON state with a slight time delay (dead time dt)) from the rise of the gate drive signal D1. Also, the second switch element 18 switches from the ON state to the OFF state at the same time as the gate drive signal D1 falls. In this way, the first switch element 16 and the second switch element 18 are switching-controlled so as to be alternately switched ON/OFF.

The reason why the first switch element 16 operates with a slight time delay (dead time dt) when the gate drive signal D1 falls and the second switch element 18 operates with a slight time delay (dead time dt) when the gate drive signal D1 rises is to prevent the first switch element 16 and the second switch element 18 from turning on at the same time. That is, the first switch element 16 and the second switch element 18 are prevented from being turned on at the same time to short-circuit the battery 10. The dead time dt that delays the operation is set to 100 ns, for example, but can be set as appropriate. During the dead time dt, the current circulates through the diode, and the state is the same as when the switch element in parallel with the circulated diode is turned on.

By such control, in the battery module 102a, the capacitor 14 and the battery 10 are disconnected from the output terminal of the battery module 102a when the gate drive signal D1 is in an OFF state (that is, the first switch element 16 is turned on and the second switch element 18 is turned off). Therefore, no voltage is output from the battery module 102a to the output terminal. In this state, as illustrated in FTG. 3A, the battery module 102a is in a through state in which the battery 10 (capacitor 14) of the battery module 102a is bypassed.

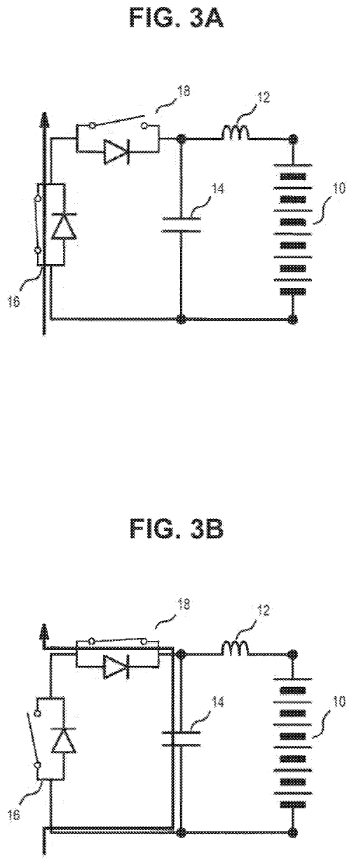

Also, when the gate drive signal D1 is in an ON state (that is, the first switch element 16 is turned off and the second switch element 18 is turned on), the capacitor 14 and the battery 10 are connected to the output terminal of the battery module 102a. Therefore, a voltage is output from the battery module 102a to the output terminal. In this state, as illustrated in FIG. 3B, the voltage V_{mod} is output to the output terminal through the capacitor 14 in the battery module 102a.

Returning to FIG. 1, the control of the power supply cinmit 100 by the controller 104 will be described hereinafter. The controller 104 controls the entire battery module 102. That is, the output voltage of the power supply circuit 100 is controlled by controlling a plurality of battery modules 102a, 102b, . . . , 102n.

The controller 104 outputs a rectangular-wave gate drive signal to each battery module 102. The gate drive signal is transmitted to the subsequent battery modules 102 in sequence, through the gate drive signal processing circuit 20 included in the battery module 102a, the gate drive signal processing circuit 20 included in the battery module 102b, and so on. That is, the gate drive signal is transmitted downstream delayed by a predetermined delay time, in order from the most upstream side of the battery modules 102 connected in series in the power supply circuit 100.

During normal control, since a high (H) level control signal is input to the AND element 22 and a low (L) level control signal is input to the OR element 24, the gate drive signal output from the gate drive signal processing circuit 20 of each battery module 102 is input to the gate terminal of the second switch element 18 as it is and the inverted signal of the gate drive signal is input to the gate terminal of the first switch element 16. Therefore, when the gate drive signal is at the high (H) level, the first switch element 16 is in the OFF state and the second switch element 18 is in the ON state, whereas when the gate drive signal is at the low (L) level, the first switch element 16 is in the ON state and the second switch element 18 is in the OFF state.

That is, when the gate drive signal is at the high (H) level, the capacitor 14 and the battery 10 in the battery module 102 are in a state (connected state) in which they are connected in series with the capacitors 14 and the batteries 10 in the other battery modules 102, whereas when the gate drive signal is at the low (L) level, the capacitor 14 and the battery 10 in the battery module 102 are in a through state in which they are disconnected from the capacitors 14 and the batteries 10 in the other battery modules 102.

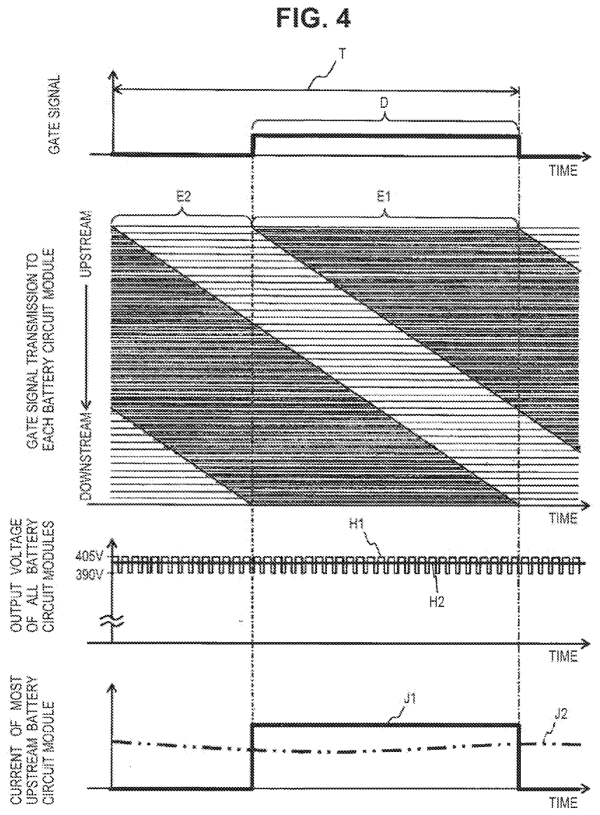

FIG. 4 illustrates a control sequence for sequentially operating a predetermined number of battery modules 102a, 102b, . . . , 102n in a connected state to output power. As illustrated in FIG. 4, according to the gate drive signal, the battery modules 102a, 102b, . . . , 102n are sequentially driven from upstream to downstream with a certain delay time. In FIG. 4, a period E1 shows a state (connected state) in which the first switch elements 16 of the battery modules 102a, 102b, . . . . , 102n are turned off and the second switch elements 18 are turned on, and thus the battery modules 102a, 102b, . . . , 102n output voltages from the output terminals. A period E2 shows a state (through state) in which the first switch elements 16 of the battery modules 102a, 102b, . . . , 102n are turned on and the second switch elements 18 are turned off, and thus the battery modules 102a, 102b, . . . , 102n output no voltage from the output terminals. In this way, the battery modules 102a, 102b, . . . 102n are sequentially driven with a certain delay time.

Setting of the gate drive signal and delay time will be described hereinafter with reference to FIG. 4. A cycle T of the gate drive signal is set by summing the delay times of the battery modules 102a, 102b, . . . , 102n. Therefore, the longer the delay time, the lower the frequency of the gate drive signal. Conversely, the shorter the delay time, the higher the frequency of the gate drive signal. The method for setting the frequency (switching frequency) will be described below.

In order to simplify the description below, the case where forced disconnection and forced connection are not performed for each battery module 102 will hereinafter be described. An on-time ratio D (on-duty) in the cycle T of the gate drive signal, that is, the ratio of a time Tₒₙ during which the gate drive signal is at the high (H) level to the cycle T is calculated by the expression of “output voltage of power supply circuit 100/total voltage (when the battery voltages of respective battery modules 102 are equal, the battery voltage of the battery module 102×the number of battery modules 102) of battery modules 102a, 102b, . . . , 102n”. That is, the relationship of “on-time ratio D=(output voltage of power supply circuit 100)/(battery voltage of battery module 102×total number of battery modules 102)” is established. Strictly speaking, the on-time ratio deviates by the dead time dt, so it is preferable to correct the on-time ratio by feedback or feedforward as is generally done in chopper circuits.

The output voltage of the power supply circuit 100 is represented by a value obtained by multiplying the battery voltage of the battery module 102 by the number of connected battery modules 102 when the battery voltages of respective battery modules 102 are equal, as described above. When the output voltage of the power supply circuit 100 is a value that can be divided by the battery voltage of one battery module 102, at the moment when a battery module 102 switches from the through state to the connected state, the other battery module 102 switches from the connected state to the through state, so there is no fluctuation in the overall output voltage of the battery module 102.

However, when the output voltage of the power supply circuit 100 is a value that cannot be divided by the battery voltage of each battery module 102, the output voltage (overall output voltage) of the power supply circuit 100 fluctuates. However, the fluctuation amplitude in this case is the voltage for one battery module, and the fluctuation cycle is calculated by the expression of “cycle T of gate drive signal/total number of battery modules 102”. By increasing the total number of battery modules 102, the fluctuation period can be shortened and the parasitic inductance of the entire power supply circuit 100 can be increased, so the voltage fluctuation can be filtered to stabilize the output voltage of the power supply circuit 100.

Next, a specific example will be described. In FIG. 4, for example, it is assumed that the desired output voltage of the power supply circuit 100 is 400 V, the battery voltage of each battery module 102 is 15 V, the number of battery modules 102a, 102b, . . . , 102n is forty, and the delay time is 200 ns. This case corresponds to the case where the output voltage (400 V) of the power supply circuit 100 is not divisible by the battery voltage (15 V) of the battery module 102.

Based on the numerical values, the cycle T of the gate drive signal is calculated by the expression of “delay time×total number of battery modules”, so the cycle T is “200 ns×40=8 μs”. Therefore, the gate drive signal is a rectangular wave with a frequency equivalent to 125 kHz. In addition, since the on-time ratio D of the gate drive signal is calculated by the expression of “output voltage of power supply circuit 100/battery voltage of battery module 102×total number of battery modules 102)”, the on-time ratio D is “400 V/(15 V×40)≅0.67”.

When the battery modules 102a, 102b, . . . , 102n are sequentially driven based on the numerical values, as illustrated in FIG. 4, an output voltage H1 having a rectangular wave shape is obtained from the power supply circuit 100. The output voltage H1 fluctuates between 390 V and 405 V. That is, the output voltage H1 fluctuates at a cycle calculated by the expression of “cycle T of gate drive signal/total number of battery modules”, that is, “8 μs/40=200 ns (equivalent to 5 MHz)”. This fluctuation is filtered by the parasitic inductance due to the wiring of the battery modules 102a, 102b, . . . , 102n, and the power supply circuit 100 as a whole outputs an output voltage H2 of about 400 V.

A current flows through the second switch element 18 of each battery module 102 in the case of the connected state, and as illustrated in FIG. 4, a current waveform J1 of the second switch element 18 becomes a rectangular wave. Also, since the battery 10 and the capacitor 14 form an RLC filter, a current J2 which is filtered and leveled flows through the battery 10 in each battery module 102. Thus, the current waveforms are uniform in all battery modules 102a, 102b, . . . , 102n, and currents can be output equally from all battery modules 102a, 102b, . . . , 102n.

As described above, when controlling the power supply circuit 100, the gate drive signal output to the most upstream battery module 102a is output to the downstream battery module 102b with a certain time delay, and then the gate drive signal is sequentially transmitted to the downstream battery modules 102 with a certain time delay. Therefore, the battery modules 102a, 102b, . . . , 102n sequentially output voltages with a certain time delay. By summing the voltages, the voltage of the power supply circuit 100 is output. Thereby, a desired voltage can be output from the power supply circuit 100.

The power supply circuit 100 eliminates the need for a DCDC converter and can simplify the circuit configuration. Further, a balance circuit or the like that causes power loss is not required, and the efficiency of the power supply circuit 100 can be improved. Furthermore, since voltages are output substantially equally from the battery modules 102a, 102b, . . . , 102n, the internal resistance loss of the power supply circuit 100 can be reduced without concentrating the drive on a specific battery module 102.

Also, by adjusting the on-time ratio D, it is possible to generate a desired output voltage equal to or less than the sum of the battery voltages, and the versatility of the power supply circuit 100 can be improved.

Forced Disconnection Control

Next, the control for forcibly disconnecting the battery 10 in the battery module 102 selected from the battery modules 102 (102a, 102b, . . . , 102n) will be described. The controller 104 outputs a forced disconnection signal to the AND element 22 and OR element 24 of the battery module 102 to be forcibly disconnected. That is, a low (L) level control signal is output to the AND element 22 belonging to the battery module 102 to be forcibly disconnected, and a low (L) level control signal is output to the OR element 24. As a result, a low (L) level is output from the AND element 22, and a high (H) level is input to the gate terminal of the first switch element 16 by the NOT element 26 via the OR element 24, and further, a low (L) level is input to the gate terminal of the second switch element 18 via the OR element 24. Therefore, the first switch element 16 is always in an ON state and the second switch element 18 is always in an OFF state, and thus the battery 10 in the corresponding battery module 102 is in a state (pass-through state) of being forcibly disconnected regardless of the state of the gate drive signal. By using such forced disconnected control, it is possible to continue the operation by performing disconnection when the battery 10 in a specific battery module 102 fails. The on-time ratio D in the case of forced disconnection is expressed by “(output voltage of power supply circuit 100)/(total voltage of battery modules 102 excluding battery module 102 in forced disconnection state)”. When a failure occurs in the batteries 10 in the battery modules 102a, 102b, . . . , 102n, by excluding the batteries 10 that have failed and using only the normal battery modules 102, the desired voltage can be obtained by resetting the cycle T of the gate drive signal and the on-time ratio D. That is, even when at failure occurs in the battery 10 in the battery modules 102a, 102b, . . . , 102n, it is possible to continue outputting the desired voltage. Moreover, the forced disconnection control can be used for control to suppress the imbalance of the SOCs of the batteries 10 in the battery modules 102 when the battery capacities of respective battery modules 102 are uneven.

For example, when the power supply circuit 100 is in a power running state, by forcibly disconnecting the battery 10 in the battery module 102 having a relatively low SOC among the batteries 10 in the battery modules 102 included in the pow supply circuit 100, the forcibly disconnected battery 10 has less power consumption (accumulated amount of discharge current per unit time), and thus the imbalance of the SOCs of the batteries 10 in the battery modules 102 can be eliminated. As a result, the SOC of the battery 10 in the battery module 102 can be brought closer to the SOC control target value. Also, it becomes possible to efficiently use up the charging energy of the battery 10 in each battery module 102.

Further, it is also possible to perform control to eliminate the imbalance of the SOCs of the batteries 10 in the battery modules 102 not in the power running state but in a regeneration state. In this case, control is performed to forcibly disconnect the battery 10 in the battery module 102 with a relatively high SOC, and by preferentially regenerating power of the battery 10 in the battery module 102 with a relatively low SOC, the imbalance of the SOCs of the batteries 10 in the battery modules 102 is eliminated. That is, the power supply (accumulated amount of charging current per unit time) to the battery 10 in the battery module 102 having a relatively high SOC among the batteries 10 in the battery modules 102 decreases, and the imbalance of the SOCs of the batteries 10 in the battery modules 102 can be eliminated. As a result, the SOC of the battery 10 in the battery module 102 can be brought closer to the SOC control target value. Also, the batteries 10 in all the battery modules 102 included in the power supply circuit 100 can be charged in a well-balanced manner. Further, overcharging of the battery 10 in the battery module 102 with a small charge capacity can be prevented.

Forced Connection Control

Next, control for forcibly connecting a selected battery 10 among the batteries 10 in the battery modules 102 (102a, 102b, . . . , 102n) will be described. The controller 104 outputs a forced connection signal to the OR element 24 of the battery module 102 to be forcibly connected. That is, a high (H) level control signal is output to the OR element 24 belonging to the battery module 102 to be forcibly connected.

As a result, a high (H) level is output from the OR element 24, and a low (L) level is input to the gate terminal of the first switch element 16 by the NOT element 26, and further, a high (H) level is input to the gate terminal of the second switch element 18. Therefore, the first switch element 16 is always in an OFF state and the second switch element 18 is always in an ON state, and thus the battery 10 the battery module 102 is in a state of being forcibly connected in series regardless of the state of the gate drive signal. Such forced connection control can be used for control to suppress the imbalance of the SOCs of the batteries 10 in the battery modules 102 in the power supply circuit 100.

For example, when the power supply circuit 100 is in the regeneration state, by forcibly connecting the battery 10 in the battery module 102 having a relatively low SOC among the batteries 10 in the battery modules 102 included in the power supply circuit 100, the forcibly connected battery 10 is preferentially charged with regenerative power and the accumulated amount of charge current per unit time increases, and thus the imbalance of the SOCs of the batteries 10 in the battery modules 102 can be eliminated. As a result, the SOC of the battery 10 in the battery module 102 can be brought closer to the SOC control target value. Also, the batteries 10 in all the battery modules 102 included in the power supply circuit 100 can be charged in a well-balanced manner.

Further, it is also possible to perform control to eliminate the imbalance of the SOCs of the batteries 10 in the battery modules 102 included in the power supply circuit 100 not in the regeneration state but in the power running state. In this case, control is performed to forcibly connect the battery 10 in the battery module 102 with a relatively high SOC, and the imbalance of the SOCs is eliminated by increasing the power consumption amount of the battery 10 in the battery module 102 having the relatively high SOC. That is, the power supply (accumulated amount of discharge current per unit time) from the battery 10 in the battery module 102 having a relatively high SOC among the batteries 10 in the battery module 102 increases, and thus the imbalance of the SOCs of the batteries 10 in the battery modules 102 can be eliminated. As a result, the SOC of the battery 10 in the battery module 102 can he brought closer to the SOC control target value. Further, it is possible to efficiently use up the charging energy of the batteries 10 in all the battery modules 102 included in the power supply circuit 100.

Specific Example of Forced Disconnection

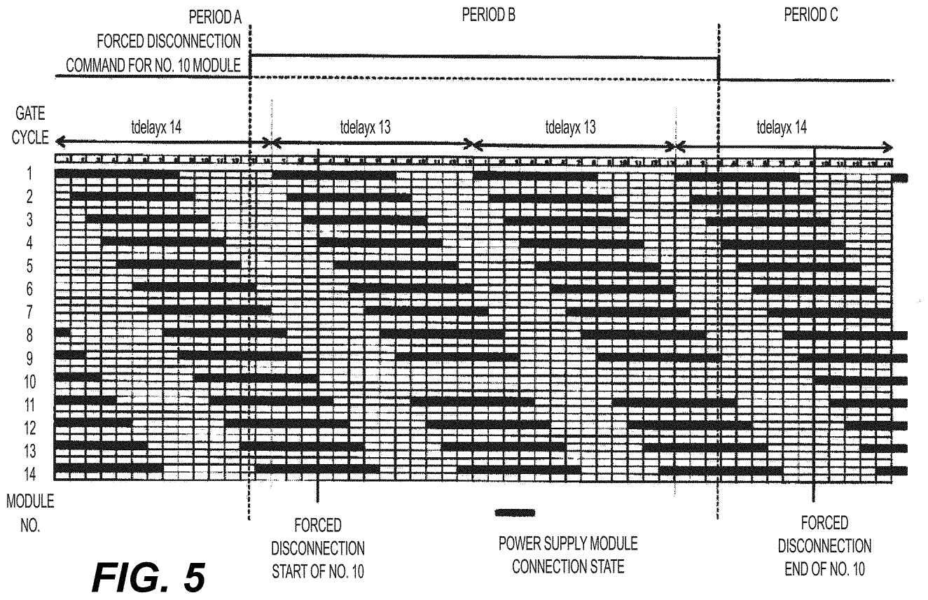

FIG. 5 illustrates a specific example of a time chart illustrating the battery connection state of each battery 10 in the battery module 102 of the power supply circuit 100 to which forced disconnection control is applied. To make the description easier to understand, a case where fourteen battery modules 102 are used is described as a specific example.

In a period A, a forced disconnection command to all battery modules 102 is turned off, and all battery modules 102 are under switching control. Each battery module 102 delays the gate drive signal by a delay time tdelay and transmits the gate drive signal to the next battery module 102 when the forced disconnection command is turned off. Therefore, the gate cycle is “(delay time tdelay×14)”.

The gate drive signal from the controller 104 has “delay time tdelay×8” as the ON time, and is controlled such that eight battery modules 102 are connected simultaneously.

In a period B, the forced disconnection signal for the tenth battery module 102 from the upstream is turned on. As a result, the output voltage of the tenth battery module 102 becomes 0 V. Also, the gate drive signal processing circuit 20 attached to the tenth battery module 102 does not delay the gate drive signal but propagates the gate drive signal to the eleventh battery module 102. As a result, the cycle until the rising edge of the gate drive signal output from the controller 104 returns to the controller 104 again becomes “delay time tdelay×13”, shortening by “delay time tdelay×1”. The controller 104 detects the rising edge of the returned gate drive signal and outputs a signal that turns on for “delay time tdelay×8” as the next gate drive signal, in this way, the eight battery modules 102 are always connected in series during the period B to output voltage to the load. That is, in the period B, the same voltage as in the period A can be output.

When the tenth battery module 102 receives the forced disconnection signal, the disconnection timing of the tenth battery module 102 is executed after the gate drive signal is turned off regardless of the gate drive signal. That is, even when the battery module 102 receives a forced disconnection signal while the battery module 102 is in the connection state, forced disconnection control is not executed while the gate drive signal is turned on, and forced disconnection is performed after the gate drive signal is turned off. Then, even when the gate drive signal is turned on in the next cycle, the forced disconnection state is continued.

In a period C, when the forced disconnection signal of the tenth battery module 102 is turned off, the tenth battery module 102 resumes normal switching control according to the gate drive signal. However, even when the forced disconnection signal is turned off at the timing when the gate drive signal for the tenth battery module 102 is turned on, the batteries 10 in the battery modules 102 are not immediately connected in series, wait for the gate drive signal to turn off, and return to normal switching control. This can prevent nine battery modules 102 from being instantaneously connected to the load.

### First Embodiment (Three-Phase Alternating Current Power Supply)

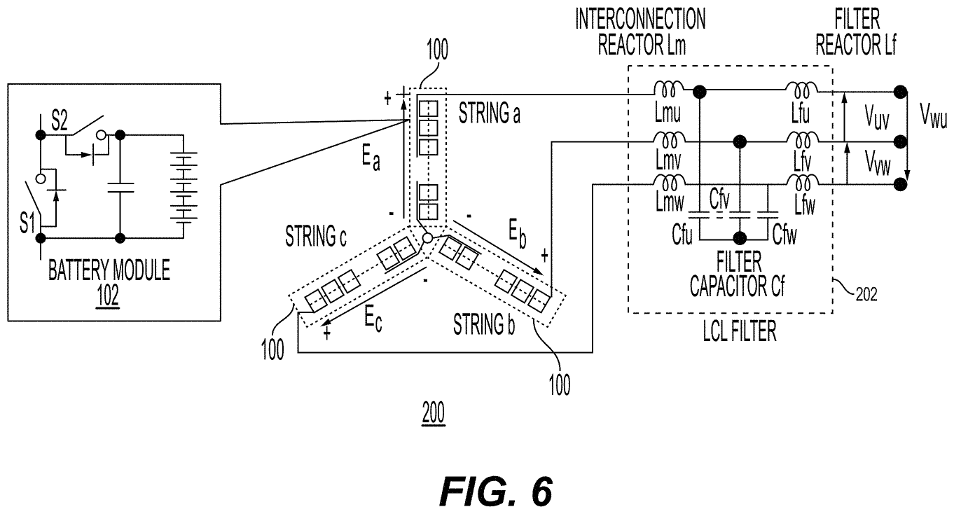

FIG. 6 illustrates the configuration of a three-phase AC power supply 200 using the power supply circuit 100. The three-phase AC power supply 200 is configured by combining three sets of power supply circuits 100.

Three sets of power supply circuits 100 (string a, string b, string c) are Y-connected such that the output voltage polarities of the respective strings are the same at the neutral point. In FIG. 6, negative sides of the three sets of power supply circuits 100 (string a, string b, string c) are connected to the neutral point, but positive sides of all the strings may be connected to the neutral point.

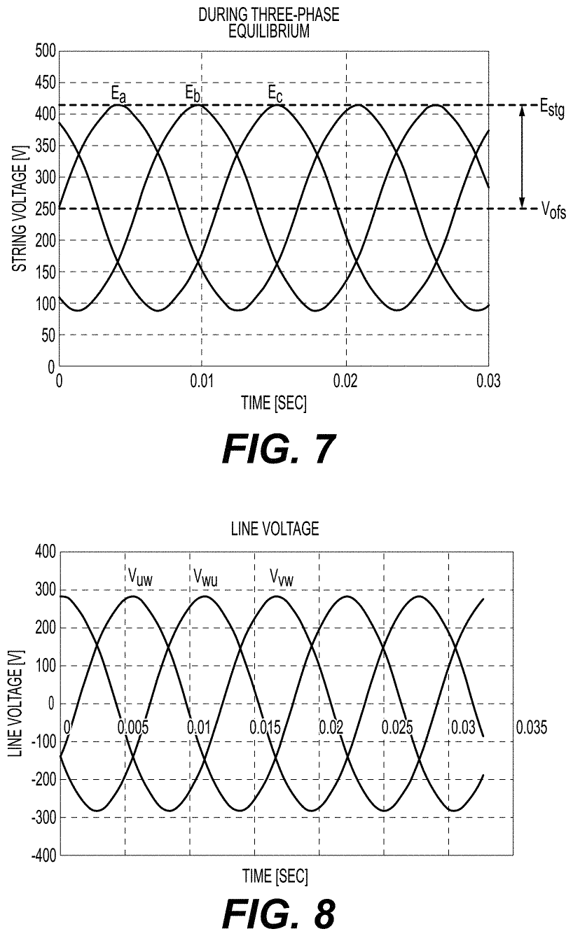

In the three-phase AC power supply 200, AC voltages Eₐ, E_{b}, and E_{c}, are generated by controlling the number of connections of the batteries 10 in the battery modules 102 in each of the three sets of power supply circuits 100 of the strings a to c. Since each of the power supply circuit 100 can only generate a voltage of 0 V or more, as illustrated in FIG. 7, voltages having an offset and a phase difference of 120° are generated as the AC voltages Eₐ, E_{b}, and E_{c}.

By generating AC voltages having the same offset voltage in the respective strings a to c, line voltages Vᵤᵥ, V_{vw}, and V_{wu}, which are AC voltages, can be generated as illustrated in FIG. 8. Thereby, manufacturing cost can be reduced by using a half-bridge circuit without using a full-bridge circuit using four switches in the battery module 102 included in the power supply circuit 100.

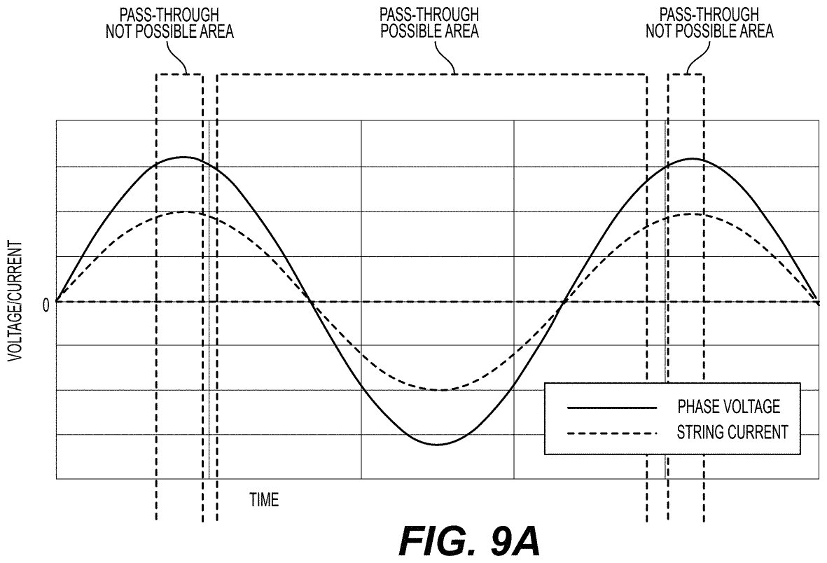

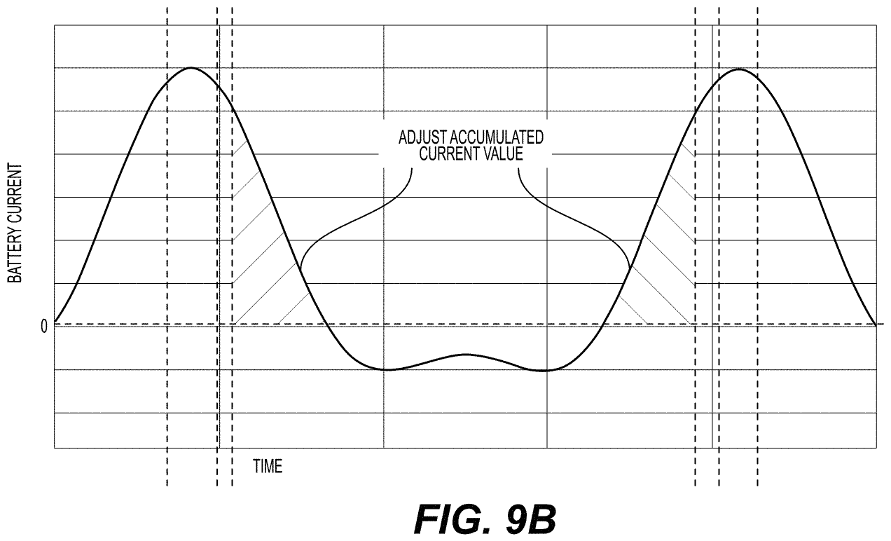

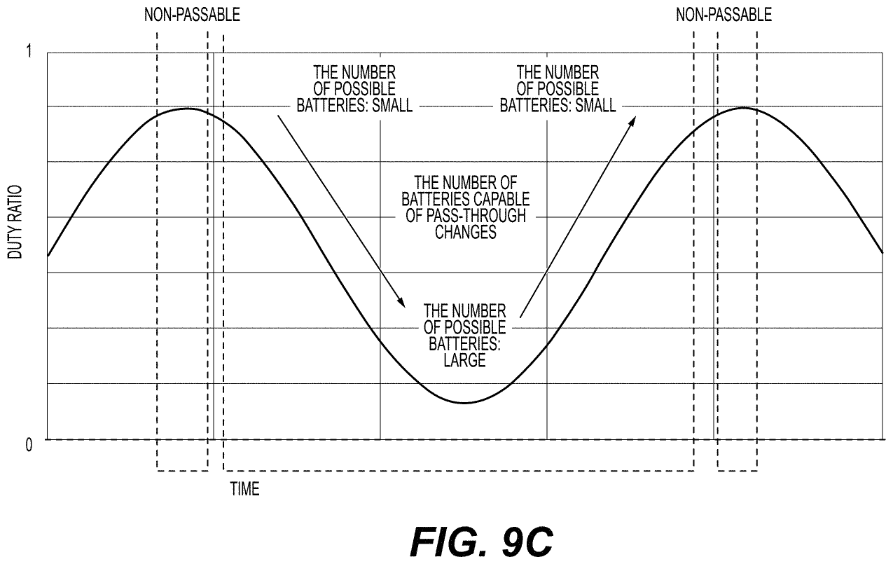

FIGS. 9A to 9C respectively illustrate examples of change over time of a phase voltage Vₐ(t), a string current Iₐ(t), a battery current I_{bat}(t), and a duty ratio D(t) of the power supply circuit 100. The phase voltage Vₐ(t), the string current Iₐ(t), the battery current I_{bat}(t), and the duty ratio D(t) are respectively expressed by Equations (1) to (4).

[Equation 1]

Vₐ(t)=Vₚₑₐₖ sin(2πf₁t) (1)

Here, Vₚₑₐₖ is the phase voltage peak value, and f₁ is the system frequency.

[Equation 2]

Iₐ(t)=Iₚₑₐₖ sin(2πf₁t) (2)

Here, Iₚₑₐₖ is the string current peak value, and f₁ is the system frequency.

$$\begin{matrix}[ Equation 3 ] & \\ {I}_{bat} ( t ) = {I}_{a} ( t ) \cdot D ( t ) & ( 3 )\end{matrix}$$

$$\begin{matrix}[ Equation 4 ] & \\ D ( t ) = \frac{{V}_{a} ( t ) + {V}_{oft}}{{V}_{all}} = \frac{{V}_{peak} sin ( 2 π {f}_{I} t ) + {V}_{oft}}{{V}_{all}} & ( 4 )\end{matrix}$$

Here, V_{oft} is the offset voltage, and Vₐₗₗ is the total string voltage.

When the AC voltage and AC current illustrated in FIG. 9A are output, the battery current illustrated in FIG. 9B flows through the battery 10 in the power supply circuit 100. Further, the gate drive duty ratio (on-time ratio D) in this case is as illustrated in FIG. 9C.

When generating an AC waveform, the number of connections of the batteries 10 in each string changes over time according to the gate drive duty ratio (on-time ratio D). Therefom, in the present embodiment, in a state of low duty ratio and low output voltage with a small number of connections of the batteries 10, by making a desired battery module 102 be in a state (pass-through state) of being forcibly disconnected from the series, the SOC is controlled by adjusting the accumulated current value of the battery 10 in the system of the power supply circuit 100. As a result, the SOC can be equalized and the battery capacity can be used more efficiently without providing an extra battery module (battery) for SOC control in the power supply circuit 100.

First Control Method for Power Supply Circuit

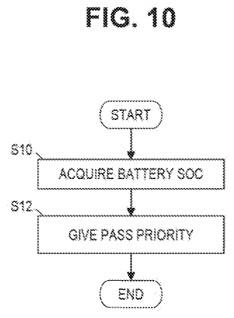

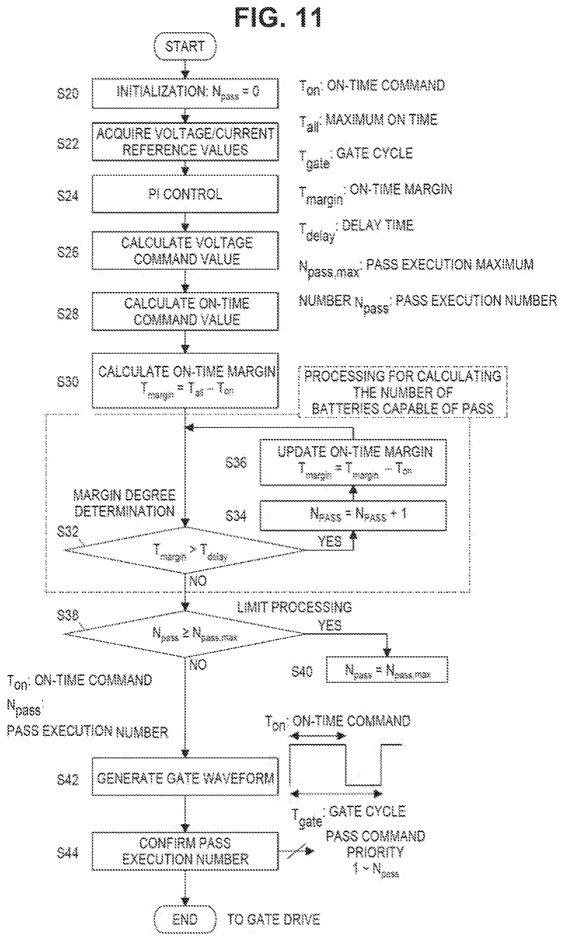

FIGS. 10 and 11 are flowcharts illustrating a first control method for the power supply circuit 100. FIG. 10 is a flowchart of processing in a long cycle that is several hundred to several thousand times as long as the system cycle (about 10 ms, for example, 16.6 ms). FIG. 11 is a flowchart of processing in a short cycle (current control cycle and carrier cycle) shorter than the system cycle.

In the long cycle process, first, the SOC of the battery 10 included in the power supply circuit 100 is acquired (step S10). Then, the priority (pass-through priority) of the battery modules 102 to be in a state (pass-through state) of being forcibly disconnected from the series is determined from the conditions of the SOCs of the batteries 10 in the battery modules 102 of each string (step S12).

Specifically, during power running (discharging) when the power supply circuit 100 outputs power, the order of priority for making the battery modules 102 be in a state (pass-through state) of being forcibly disconnected from series is determined in ascending order of SOC. During regeneration (charging) in which the power supply circuit 100 recovers power, the order of priority for making the battery modules 102 be in a state (pass-through state) of being forcibly disconnected from series is determined in descending order of SOC.

A current control cycle process is a process for controlling AC current in system interconnection. In the short cycle process, the process is executed in the current control cycle in steps S20 to S40, and the process is executed in the carrier cycle in steps S42 to S44.

First, in steps S20 to S28, a voltage command value and an on-time command value for each string of the power supply circuit 100 are calculated. First, a pass execution number Nₚₐₛₛ is initialized to 0 (step S20). The pass execution number Nₚₐₛₛ indicates the number of battery modules 102 that are made to be in the state (pass-through state) of being forcibly disconnected from series in each string of the power supply circuit 100.

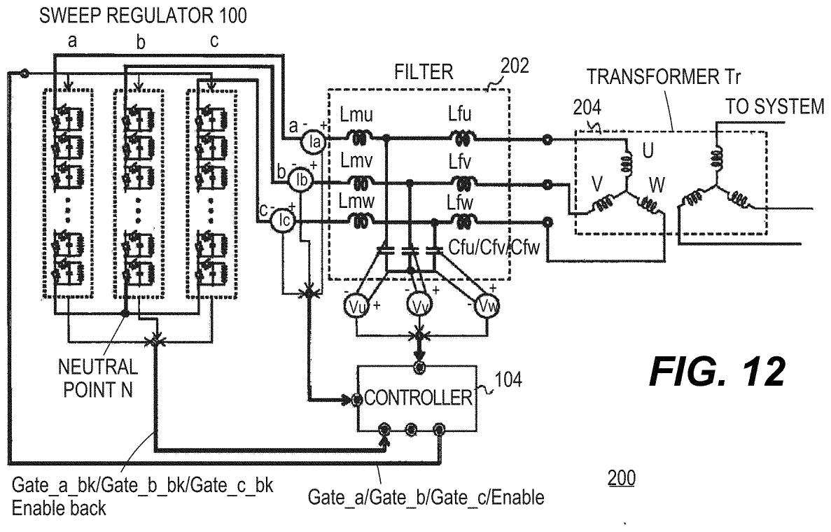

The output terminals of the strings a to c are connected to a filter 202. As illustrated in FIG. 12, the filter 202 can be configured including interconnection reactors Lₘ (Lₘᵤ, Lₘᵥ, L_{mw}), filter capacitors C_{f} (C_{fu}, C_{fv}, C_{fw}), and filter reactors L_{f} (L_{fu}, L_{fv}, L_{fw}). The filter 202 is provided for each phase of the strings a to c. The filter capacitor is neutral connected. The output of the filter 202 is connected to the secondary side of a transformer 204. A relay may be provided between the filter 202 and the transformer 204.

Current sensors (Iₐ, I_{b}, I_{c}) are also provided to measure output currents of the strings a to c. The current sensors may be installed for only two phases and the remaining one phase may be calculated from the measured two phase currents. For example, when the a-phase current Iₐ and the b-phase current I_{b} are measured, the c-phase current I_{c} can be calculated by Equation (5).

[Equation 5]

I_{c}=−Iₐ−I_{b} (5)

Voltage sensors (Vᵤ, Vᵥ, V_{w}) are also provided to measure three filter capacitor voltages of the filter 202. By measuring the filter capacitor voltage, each phase voltage of the system can be measured.

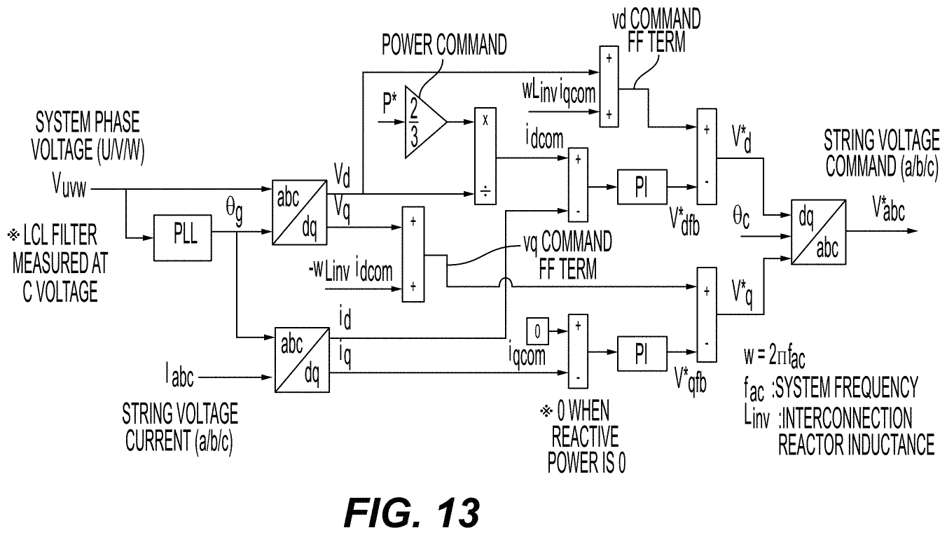

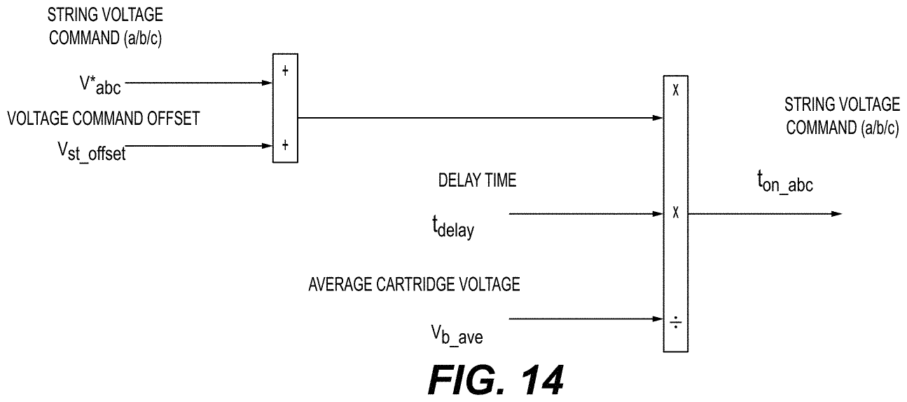

Details of the system interconnection control of the three-phase AC power supply 200 will be described below. FIGS. 13 and 14 illustrate block diagrams of the system interconnection control.

Calculation of voltage command values for the strings a to c will be described hereinafter with reference to FIG. 13. First, using the measured values Vᵤ, Vᵥ, and V_{w} of the system phase voltages measured by the voltage sensors provided in the three filter capacitors C_{fu}, C_{fv}, and C_{fw} of the filter 202, a phase θg of the system voltage is calculated by a phase locked loop (PLL).

Next, dq-axis voltages v_{d} and v_{q} are calculated by performing abc/dq conversion using the voltage phase θg and the system phase voltages Vᵤ, Vᵥ and V_{w}. The abc/dq conversion can be performed by Equations (6) and (7). Here, the system phase voltages Vᵤ, Vᵥ, and V_{w} may be substituted for uₐ, u_{b}, and u_{c} in Equation (6).

$$\begin{matrix}[ Equation 6 ] & \\ ( \begin{matrix}\begin{matrix}{u}_{d} \\ {u}_{q}\end{matrix} \\ {u}_{0}\end{matrix} ) = \frac{2}{3} ( \begin{matrix}sin {θ}_{a} & sin {θ}_{b} & sin {θ}_{c} \\ cos {θ}_{a} & cos {θ}_{b} & cos {θ}_{c} \\ \frac{1}{2} & \frac{1}{2} & \frac{1}{2}\end{matrix} ) ( \begin{matrix}\begin{matrix}{u}_{a} \\ {u}_{b}\end{matrix} \\ {u}_{c}\end{matrix} ) & ( 6 )\end{matrix}$$

A d-axis current i_{d} and a q-axis current i_{q} can be calculated by substituting the output currents Iₐ, I_{b}, and I_{c} of the strings a to c for uₐ, u_{b}, and u_{c} in Equation (6) and performing dq conversion.

$$\begin{matrix}[ Equation 7 ] & \\ {θ}_{a} = {θ}_{g} & ( 7 )\end{matrix}$$

$${θ}_{b} = {θ}_{g} - \frac{2}{3} π$$

$${θ}_{c} = {θ}_{g} + \frac{2}{3} π$$

Next, the current command values for the dq axes are obtained. Assuming that a command power P for the entire three-phase AC power supply 200 is used, a d-axis command current i_{dcom} is calculated from Equation (8) by using a d-axis voltage v_{d} and the command power P. A q-axis current command value i_{qcom} is set to 0 when controlling the reactive power to zero.

$$\begin{matrix}[ Equation 8 ] & \\ {i}_{dcom} = \frac{2}{3} \frac{P}{{V}_{d}} & ( 8 )\end{matrix}$$

Next, using the d-axis command current i_{dcom}, the q-axis command current i_{qcom}, the d-axis current i_{d}, and the q-axis current i_{q}, dq-axis command voltage feedback terms vdfb* and vqfb* are calculated by PI control. By adding the feedback terms to a vd command feedforward term and a vq command feedforward term, dq-axis voltage command values v_{d}* and v_{q}* are calculated. Further, string voltage command values V_{str.com} (Vₐ*, V_{b}*, V_{c}*) are calculated by converting from the dq axis to the three-phase abc axis. Equation (9) may be used for the dq/abc conversion.

$$\begin{matrix}[ Equation 9 ] & \\ ( \begin{matrix}\begin{matrix}{u}_{a} \\ {u}_{b}\end{matrix} \\ {u}_{c}\end{matrix} ) = \frac{2}{3} ( \begin{matrix}sin {θ}_{a} & cos {θ}_{a} & 1 \\ sin {θ}_{b} & cos {θ}_{b} & 1 \\ sin {θ}_{c} & cos {θ}_{c} & 1\end{matrix} ) ( \begin{matrix}\begin{matrix}{u}_{a} \\ {u}_{b}\end{matrix} \\ {u}_{c}\end{matrix} ) & ( 9 )\end{matrix}$$

Next, using the string voltage command values V_{str,com}, on-time commands Tₒₙ (t_{on_a}, t_{on_b}, t_{on_c}) of the a-phase, b-phase, and c-phase power supply circuits 100 are calculated using Equation (10).

$$\begin{matrix}[ Equation 10 ] & \\ {t}_{on \_ abc} = ( {V}_{abc}^{⋆} + {V}_{st \_ offset} ) \times \frac{{t}_{delay}}{{V}_{b \_ ave \_ abc}} & ( 10 )\end{matrix}$$

Here, V*_{abc} is one of the voltage command values V_{str.com} (Vₐ*, V_{b}*, V_{c}*) of phase a, phase b, and phase c, V_{st_offset} is the voltage command offset value, a t_{delay} is the delay time of the Gate signal in each power supply circuit module, and V_{b_ave_abc} is the battery module average voltage of each of the strings a, b, and c each of which is the power supply circuit 100. The offset value added to the voltage command value for each of the strings a, b, and c is preferably set to the same value for the a-phase, b-phase, and c-phase.

The following processing is performed for each string. Hereinafter, the t_{on_a}, the t_{on_b}, or the t_{on_c} for each string is simply referred to as an on-time command Tₒₙ. Next, an on-time margin T_{margin} is calculated (step S30). The on-time margin T_{margin} is, as shown in Equation (11), a value obtained by subtracting the on-time command Tₒₙ (t_{on_a}, t_{on_b}, t_{on_c}) calculated by Equation (10) from a maximum on time Tₐₗₗ for each of the strings a, b, and c.

[Equation 11]

T_{margin}=Tₐₗₗ−Tₒₙ (11)

The on-time margin T_{margin} and the delay time T_{delay} in one battery module 102 are compared (step S32). Then, when the on-time margin T_{margin} is greater than the delay time T_{delay}, the process proceeds to step S34, whereas when the on-time margin T_{margin} is equal to or less than the delay time T_{delay}, the process proceeds to step S38. That is, when one battery module 102 is connected, the on-time command Tₒₙ increases by the delay time T_{delay}, so it is determined that pass-through is possible when there is an on-time margin T_{margin} equal to or greater than the delay time T_{delay}. When the process proceeds to step S34, the pass execution number Nₚₐₛₛ is incremented by 1 (step S34), and a process of setting a value obtained by subtracting the on-time command Tₒₙ from the on-time margin T_{margin} as a new on-time margin T_{margin} is performed (step S36). The pass execution number Nₚₐₛₛ is calculated by repeating the processing of steps S32 to S36.

When the process proceeds to step S38, it is determined whether the pass execution number Nₚₐₛₛ is equal to or greater than a pass execution maximum number N_{pass,max} (step S38). When the pass execution number Nₚₐₛₛ is equal to or greater than the pass execution maximum number N_{pass,max}, the pass execution number Nₚₐₛₛ is set to the pass execution maximum number N_{pass,max} (step S40). Here, the pass execution maximum number N_{pass,max} may be set to the maximum number of battery modules 102 that can execute a pass in AC active balance.

Through the above processing, the on-time command Tₒₙ and the pass execution number Nₚₐₛₛ are obtained, and the waveform of the gate signal is generated based on the values. That is, as illustrated in FIG. 11, a gate signal, which is a pulse waveform that is at a high level only during the period of the on-time command Tₒₙ in a gate cycle Tgate for each string, is generated (step S42). In this way, the pass execution number Nₚₐₛₛ is determined, and according to the priority (pass-through priority) of the battery modules 102 obtained in the long cycle process, the battery modifies 102 corresponding to the number of the pass execution number Nₚₐₛₛ are made to be in the state (pass-through state) of being forcibly disconnected from the series (step S44).

Second Control Method for Power Supply Circuit

In the first control method, the pass execution number Nₚₐₛₛ is determined based on the on-time command Tₒₙ, but the pass execution number Nₚₐₛₛ may be determined based on the voltage command value V_{str.com}.

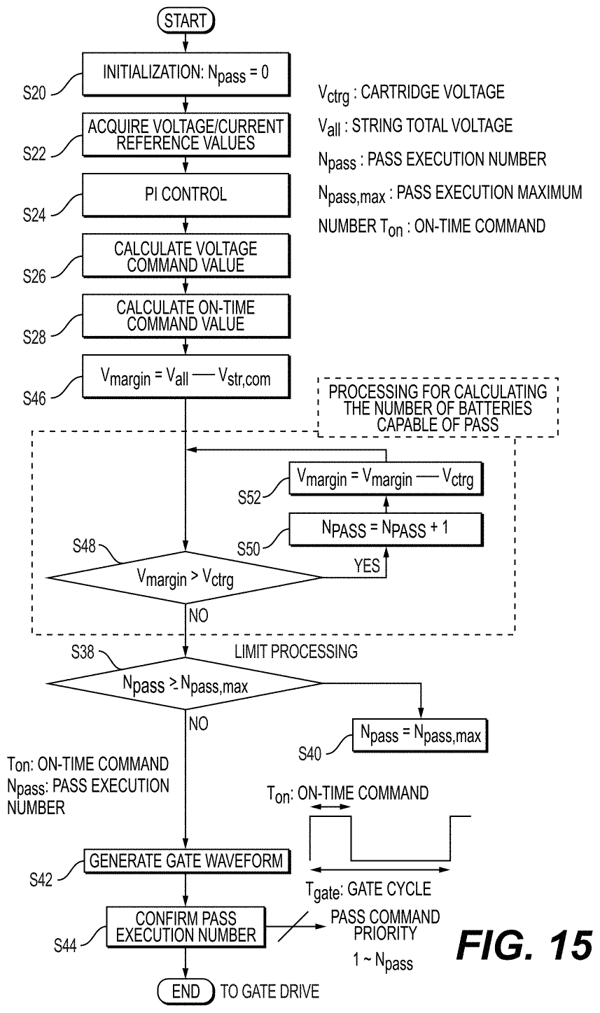

FIG. 15 is a flowchart illustrating a second control method for the power supply circuit 100. The long cycle process in the second control method is the same as in the first control method, so description thereof will be omitted. FIG. 15 is a flowchart of processing in a short cycle (current control cycle and carrier cycle) shorter than the system cycle.

In the short cycle process, the process is executed in the current control cycle in steps S20 to S26, steps S46 to S52, and steps S38 to S40, and the process is executed in the carrier cycle in steps S42 to S44.

First, in steps S20 to S26, a voltage command value V_{str.com}, which is a command value for the voltage to be output from each string of the power supply circuit 100, is calculated. The process is the same as that of the first control method described above, so description thereof will be omitted.

Next, a voltage margin V_{margin} is calculated (step S46). The voltage margin V_{margin} is a value obtained by subtracting the voltage command value V_{str.com} from the maximum voltage (battery total voltage that can be output from each string) Vₐₗₗ in each of the strings A, B, and C, as expressed in Equation (12).

[Equation 12]

V_{margin}=Vₐₗₗ−V_{str.com} (12)

The voltage margin V_{margin} and a cartridge voltage V_{ctrg} indicating the output voltage in one battery module 102 are compared (step S48). Then, when the voltage margin V_{margin} is larger than the cartridge voltage V_{ctrg}, the process proceeds to step S50, whereas when the voltage margin V_{margin} is equal to or less than the cartridge voltage V_{ctrg}, the process proceeds to step S38. That is, when one battery module 102 is connected, the output voltage increases by the cartridge voltage V_{ctrg}, so it is determined that pass-through is possible when there is a voltage margin V_{margin} equal to or greater than the cartridge voltage V_{ctrg}. When the process proceeds to step S50, the pass execution number Nₚₐₛₛ is incremented by 1 (step S50), and a process of setting a value obtained by subtracting the cartridge voltage V_{ctrg} from the voltage margin V_{margin} as a new voltage margin V_{margin} is performed (step S52). The pass execution number Nₚₐₛₛ is calculated by repeating the processing of steps S48 to S52.

The processing of steps S38 to S44 after the pass execution number Nₚₐₛₛ is calculated is the same as that of the first control method, so description thereof will be omitted.

Operations and Effects of Present Embodiment

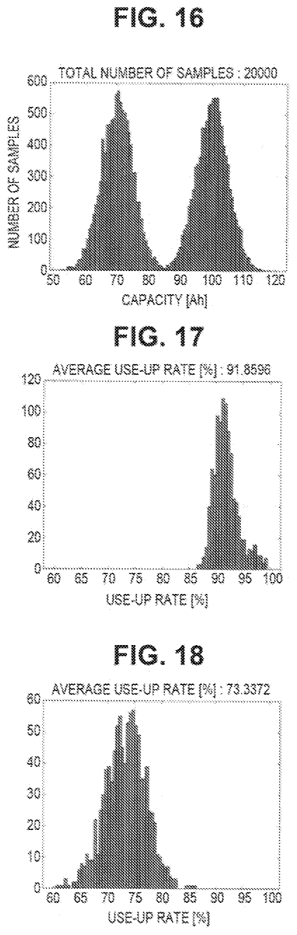

FIGS. 16 to 23 illustrate results of simulating a use-up rate of the battery capacity of the battery module 102 in each string.

With the distribution (FIGS. 16 and 20) of the battery modules 102 in which the capacities are distributed in a state of superposition of two normal distributions as a population, N battery modules 102 are selected at random from among them, and a string is formed from the selected N battery modules 102 to perform a simulation. The two distributions of the battery modules 102 are a distribution 1 with an average battery capacity of 70 Ah and a standard deviation of 5 Ah, and a distribution 2 with an average battery capacity of 100 Ah and a standard deviation of 5 Ah. The simulation is performed under three conditions: when control according to the present embodiment is performed (AC active balance control), when the DC active balance control of the related art is performed, and when active balance control is not performed. In the simulation, batteries are used, and when any one battery reaches the minimum capacity, all battery use is ended, and then the remaining cartridge capacity of each battery module 102 at that time is taken as an unused capacity, and how much of the initial capacity is used up is calculated as the use-up rate of the battery capacity. Such processing is repeated ten thousand times, and the distribution and average value of the use-up rates of the battery capacities are calculated.

FIGS. 17 to 19 respectively illustrate the cases in which AC active balance control is performed, DC active balance control is performed, and active balance control is not performed in a string configuration without a battery module 102 having an extra buffer battery in the string

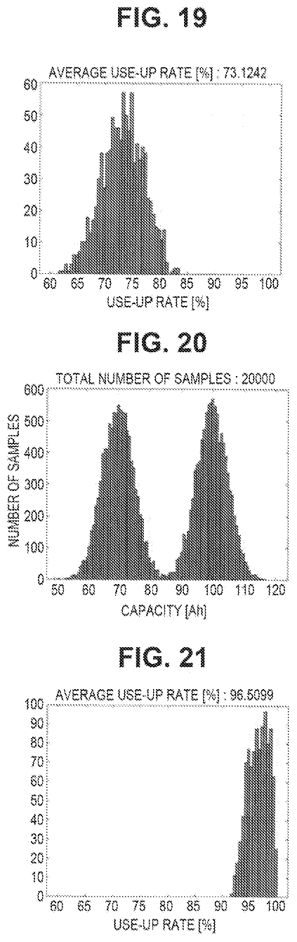

As illustrated in FIGS. 18 and 19, in the configuration without a buffer battery in the string, the battery module 102 cannot be made to be in the state (pass-through state) of being forcibly disconnected from the series under the DC active balance control, and the distribution of the use-up rates of the battery capacities indicates almost the same distribution as that without active balance control. Under the DC active balance control, the average value of the use-up rates of the battery capacities is about 73%, and the minimum value thereof is about 62%. Further, without the active balance control, the average value of the use-up rates of the battery capacities is about 73%, and the minimum value thereof as about 60%. On the other hand, as illustrated in FIG. 17, under the AC active balance control in the present embodiment, the use-up rate of the battery capacity is high even in the configuration without a buffer battery in the string. Under the AC active balance control, the average value of the use-up rates of the battery capacities is about 92%, and the minimum value thereof is about 87%.

FIGS. 21 to 23 respectively illustrate the cases in which AC active balance control is performed, DC active balance control is performed, and active balance control is not performed in a string configuration with a battery module 102 having one buffer battery in the string

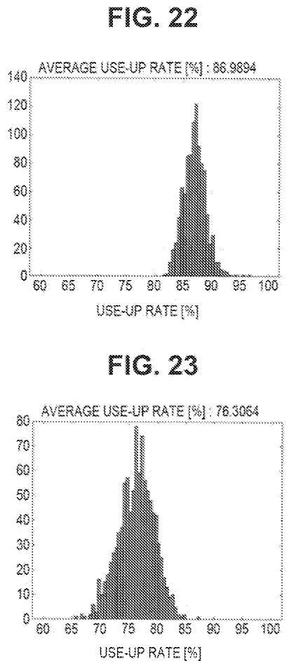

In the configuration with on buffer battery in the string, the battery module 102 can be made to be in the state (pass-through state) of being forcibly disconnected from the series even in the DC active balance control. As a result, as illustrated in FIGS. 22 and 23, under the DC active balance control, the use-up rate of the battery capacity is improved compared to that without the active balance control. Under the DC active balance control, the average value of the use-up rates of the battery capacities is about 87%, and the minimum value thereof is about 82%. Without the active balance control, the average value of the use-up rates of the battery capacities is about 76%, and the minimum value thereof is about 66%. Furthermore, as illustrated in FIG. 21, under the AC active balance control in the present embodiment, the use-up rate of the battery capacity is further improved in the configuration with one buffer battery in the string. Under the AC active balance control, the average value of the use-up rates of the battery capacities is about 97%, and the minimum value thereof is about 92%.

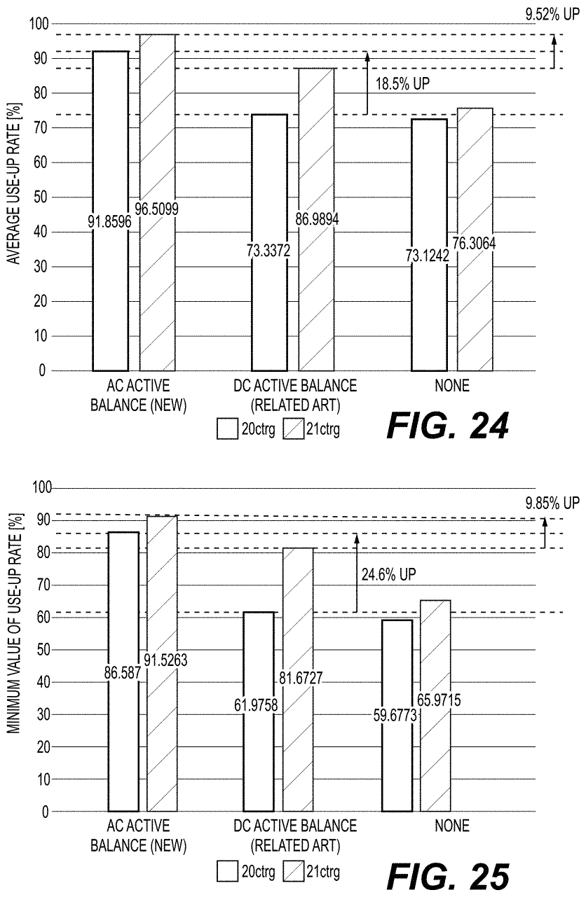

FIGS. 24 and 25 summarize the simulation results. FIG. 24 illustrates the results of summarizing the average values of the use-up rates of the battery capacities. FIG. 25 illustrates the results of summarizing the minimum values of the use-up rates of the battery capacities. In FIGS. 24 and 25, filled-in bars illustrate the results in the configuration (the string configured with twenty battery modules 102) without a buffer battery in the string, and hatched bars illustrate the results in the configuration (the string configured with twenty-one battery modules 102) with one buffer battery in the string.

By applying the AC active balance control in the present embodiment, even in the configuration without a buffer battery in the string, the average value of the use-up rates of the battery capacities can be made 90% or more. Further, when the AC active balance control in the present embodiment and the DC active balance control of the related art are compared, the use-up rate of the battery capacity can be improved by 18.5% in the configuration without a buffer battery, and the use-up rate of the battery capacity can be improved by 9.5% in the configuration with one buffer battery.

In other words, by applying the AC active balance control in the present embodiment, the battery capacities of the batteries in the battery modules 102 forming the string can be used up more efficiently.

What is claimed is:

1. A power supply system that uses a plurality of sets of battery module groups each including a plurality of battery modules with batteries and makes the batteries in the battery modules to be connectable in series based on a gate drive signal from a controller, the power supply system comprising:
a forcible disconnecting unit configured to forcibly disconnect the battery in the battery module from the series regardless of the gate drive signal,
wherein the power supply system is configured to:
obtain the number of batteries included in the battery modules which are forcibly disconnectable from the series according to a maximum voltage of the batteries that are connectable in the series and a voltage command value indicating a voltage to be output; and
forcibly disconnect the obtained number of the batteries from the series by the forcible disconnecting unit.

2. A power supply system that uses a plurality or sets of battery module groups each including a plurality of battery modules with batteries and makes the batteries in the battery modules to be connectable in series based on a gate drive signal from a controller, the power supply system comprising:
a forcible disconnecting unit configured to forcibly disconnect the battery in the battery module from the series regardless of the gate drive signal,
wherein the power supply system is configured to:
obtain the number of batteries included in the battery modules which are forcibly disconnectable from the series according to a maximum allowance on-time and an on-time command; and
forcibly disconnect the obtained number of the batteries from the series by the forcible disconnecting unit.

3. The power supply system according to claim 1, wherein the power supply system is configured to, when there is a margin in an output voltage with respect to a maximum voltage of the batteries that are connectable in the series, perform a process of forcibly disconnecting the obtained number of the batteries from the series by the forcible disconnecting unit.

4. The power supply system according to claim 1, wherein the power supply system is configured to, during discharging, perform a process of forcibly disconnecting the obtained number of the batteries from the series by the forcible disconnecting unit in ascending order of state of charge.

5. The power supply system according to claim 1, wherein the power supply system is configured to, during charging, perform a process of forcibly disconnecting the obtained number of the batteries from the series by the forcible disconnecting unit in descending order of state of charge.

6. The power supply system according to claim 1, wherein the power supply system is configured to make at least three sets of the battery module groups Y-connected and cause the battery is groups to respectively output alternating current voltages with a 120° phase difference.

7. The power supply system according to claim 2, wherein the power supply system is configured to, when there is a margin in an output voltage with respect to a maximum voltage of the batteries that are connectable in the series, perform a process of forcibly disconnecting the obtained number of the batteries from the series by the forcible disconnecting unit.

8. The power supply system according to claim 2, wherein the power supply system is configured to, during discharging, perform a process of forcibly disconnecting the obtained number of the batteries from the series by the forcible disconnecting unit in ascending order of state of charge.

9. The power supply system according to claim 2, wherein the power supply system is configured to, during charging, perform a process of forcibly disconnecting the obtained number of the batteries from the series by the forcible disconnecting unit in descending order of state of charge.

10. The power supply system according to claim 2, wherein the power supply system is configured to make at least three sets of the battery module groups Y-connected and cause the battery module groups to respectively output alternating current voltages with a 120° phase difference.
